(19) United States
(12) Patent Application Publication
(10) Pub. No.: US 2015/0298897 A1
(43) Pub. Date: Oct. 22, 2015

(54) CAPSULE FOR USE IN COFFEE EXTRACTION MACHINES

(71) Applicant: BEAN TECHNOLOGIES LIMITED, Port Louis (MU)

(72) Inventor: Anthony Kay, Clifton (ZA)

(21) Appl. No.: 14/441,663

(22) PCT Filed: Nov. 8, 2013
(86) PCT No.: PCT/IB2013/059998

§ 371 Date: May 8, 2015

(30) Foreign Application Priority Data
Nov. 9, 2012 (ZA) 2012/08442
Feb. 20, 2013 (ZA) 2013/01297
Mar. 8, 2013 (ZA) 2013/01782

(51) Int. Cl. B65D 85/804; A23F 5/24

(52) U.S. Cl. CPC B65D 85/8043; A23F 5/24

(57) ABSTRACT

A capsule for containing ground coffee is disclosed, the capsule comprising a frustoconical side wall (12) of truncated conical form which is closed at its narrower end by a base (16) and which has at the wider end a flange (14) which encircles the side wall (12) and extends radially outwardly. The flange (14) has a first surface to which a foil is secured to close the capsule and a further surface which faces the pressing sleeve of the extraction machine when the capsule is placed in the machine prior to extraction taking place. A grid pattern of intersecting sealing ribs is provided on the further surface which ribs stand proud of the further surface.

### FIELD OF THE INVENTION

This invention relates to capsules for use in coffee extraction machines.

### BACKGROUND TO THE INVENTION

Coffee extraction machines sold under the name “Nespresso” (registered trade mark) use capsules which contain ground coffee. Each capsule comprises a wall of truncated form which is closed at its smaller diameter end by a base and at its larger diameter end by a foil which is secured to a radially outwardly protruding flange of the capsule.

The capsule is placed in the machine and the machine is then closed. As the machine closes the bottom of the base of the capsule is punctured by one or more spikes. Hot water is then forced through the openings formed by the spikes into the coffee in the capsule. The water forces the foil which seals the larger diameter end of the capsule against a plate which has a multitude of raised areas interspersed with depressed areas. This results in the foil failing in a multitude of areas due to water pressure in the capsule thereby to produce openings through which coffee extract can flow from the capsule.

The extraction machine includes a pressing sleeve which is forced against the underside of the flange of the capsule. Behind the capsule there is a chamber to which hot water under pressure is fed. Water passes from this chamber through the puncture holes in the base and into the capsule. Sealing between the flange and the sleeve is essential to prevent water leaking between the pressing sleeve and the capsule's flange and consequently not passing through the puncture holes into the capsule.

The present invention seeks to provide a coffee capsule with an improved sealing structure.

### BRIEF DESCRIPTION OF THE INVENTION

According to one aspect of the present invention there is provided a capsule for containing ground coffee, the capsule comprising a frustoconical side wall of truncated conical form which is closed at its narrower end by a base and which has at the wider end a flange which encircles the side wall and extends radially outwardly therefrom, the flange having a first surface to which a foil is secured to close the capsule and an opposed surface which faces the pressing sleeve of the extraction machine when the capsule is placed in the machine prior to extraction taking place, there being a grid pattern of intersecting sealing ribs on said opposed surface which ribs stand proud of said opposed surface.

In the preferred form there are continuous circumferentially extending concentric ribs which intersect a plurality of radially extending ribs to form said grid pattern.

According to a further aspect of the present invention there is provided a capsule for containing ground coffee, the capsule comprising a frustoconical side wall of truncated conical form which is closed at its narrower end by a base and which has at the wider end a flange which encircles the side wall and extends radially outwardly therefrom, the flange having a first surface to which a foil is secured to close the capsule and an opposed surface which faces the pressing sleeve of the extraction machine when the capsule is placed in the machine prior to extraction taking place, there being a plurality of radially extending sealing ribs on said opposed surface which ribs stand proud of said opposed surface.

According to another aspect of the present invention there is provided a capsule for containing ground coffee, the capsule comprising a frustoconical side wall of truncated conical form which is closed at its narrower end by a base and which has at the wider end a flange which encircles the side wall and extends radially outwardly therefrom, there being a strengthening bead around the periphery of said flange, the flange having a first surface to which a foil is secured to close the capsule and an opposed surface which faces the pressing sleeve of the extraction machine when the capsule is placed in the machine prior to extraction taking place, there being a plurality of sealing ribs on said opposed surface which ribs stand proud of said opposed surface and extend from said wall to said bead.

According to the present invention there is provided a capsule for containing ground coffee, the capsule comprising a frustoconical side wall of truncated conical form which is closed at its narrower end by a base and which has at the wider end a flange which encircles the side wall and extends radially outwardly therefrom, the flange having a first surface to which a foil is secured to close the capsule and an opposed surface which faces the pressing sleeve of the extraction machine when the capsule is placed in the machine prior to extraction taking place, there being intersecting sealing ribs on said opposed surface which ribs stand proud of said opposed surface, there being ribs which extend radially and which intersect ribs that extend circumferentially, the ribs being triangular in cross section with their bases integral with the flange.

The pairs sloping flanks which bound each rib can intersect with one another at an angle of between 25 and 45 degrees. This provides satisfactory sealing even if the capsule and pressing sleeve are not exactly co-axial. The preferred angle is between 30 to 40 degrees.

An included angle of 35 degrees has been found to provide a reliable seal.

According to the present invention there is provided a capsule for containing ground coffee, the capsule comprising a frustoconical side wall of truncated conical form which is closed at its narrower end by a base and which has at the wider end a flange which encircles the side wall and extends radially outwardly therefrom, the flange having a first surface to which a foil is secured to close the capsule and an opposed surface which faces the pressing sleeve of the extraction machine when the capsule is placed in the machine prior to extraction taking place, there being intersecting sealing ribs on said opposed surface which ribs stand proud of said opposed surface, there being ribs which extend radially and which intersect ribs that extend circumferentially, the ribs being triangular in cross section with their bases integral with the flange, the ribs being located in two sealing zones constituted by a radially inner ring of ribs and a radially outer ring of ribs, the ribs of the radially inner ring being greater in height and base width than the ribs of the outer ring.

The outer ring can comprise more radially extending and circumferentially extending ribs than the inner ring. The inner ring can comprise two circumferentially extending rib one of which intersects the radially extending ribs midway between their radially inner and radially outer ends. The other of these ribs can constitute the radially outer edge of the inner ring. The outer ring can comprise five circumferentially extending ribs.

The sloping flanks which bound each rib can intersect with one another at an angle of between 25 and 45 degrees. This provides satisfactory sealing even if the capsule and pressing sleeve are not exactly co-axial. The preferred angle is between 30 to 40 degrees.

Included angles of 28 to 35 degrees has been found to provide a reliable seal.

A strengthening bead of substantially square cross-section can be provided around the periphery of the flange.

### BRIEF DESCRIPTION OF THE DRAWINGS

For a better understanding of the present invention, and to show how the same may be carried into effect, reference will now be made, by way of example, to the accompanying drawings in which;

FIG. 1 is an elevation of a capsule for containing coffee;

FIG. 2 is a plan view of the capsule from above;

FIGS. 3 and 4 are sections through the capsule of FIGS. 1 and 2 taken on the lines III-III and IV-IV of FIGS. 1 and 2;

FIG. 5 is a plan view of the capsule in a inverted position and to a larger scale;

FIG. 6 is a view of a further form of capsule viewed from below its flange;

FIG. 7 is a section, to a larger scale, through the flange of the capsule of FIG. 6 and illustrates its sealing structure;

FIGS. 8 and 9 illustrate details of the sealing structure of FIG. 6;

FIG. 10 is a view of part of another form of capsule viewed from below its flange; and

FIG. 11 is a pictorial view of the sealing structure of the capsule of FIG. 10.

### DETAILED DESCRIPTION OF THE DRAWINGS

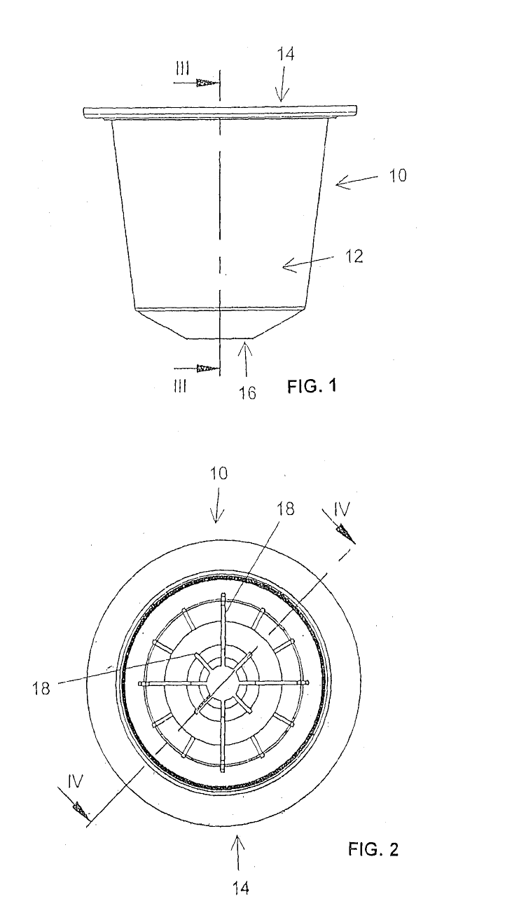

The capsule 10 illustrated in FIGS. 1 to 5 of the drawings comprises a wall 12 in the form of a truncated cone, a flange 14 extending outwardly from the larger diameter end of the wall 12 and a base 16 at the smaller diameter end of the wall 12. Alternating long and short longitudinally extending strengthening ribs 18 are provided within the space defined by the wall 12 and the base 16.

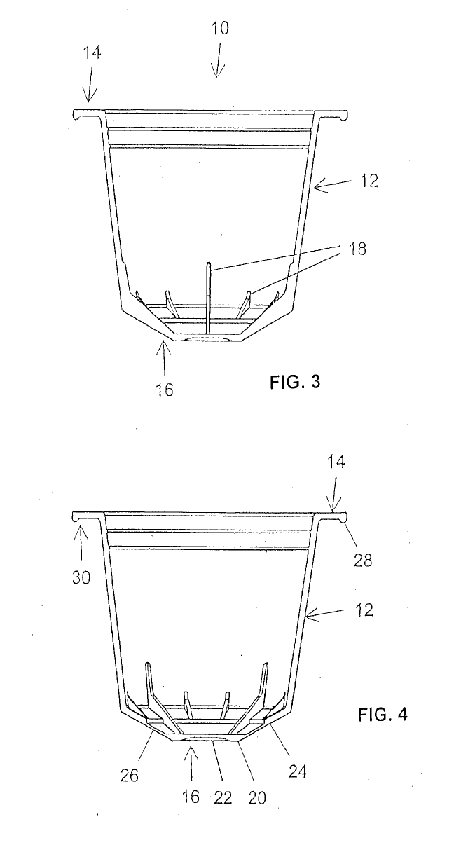

The base 16, see particularly FIGS. 3 and 4, comprises a circular base section 20 with a recess 22 in the external face thereof. A frustoconical section 24 of the base 16 is of the same thickness as the wall 12 and there is an intermediate frustoconical section 26 between the sections 20 and 24. The wall thickness of the section 26 is less than that of the sections 20 and 24, thereby to facilitate penetration by the spikes of a coffee extraction machine as will be described.

There is a strengthening bead 28 around the outer periphery of the flange 14 which minimises flexing of the flange during extraction.

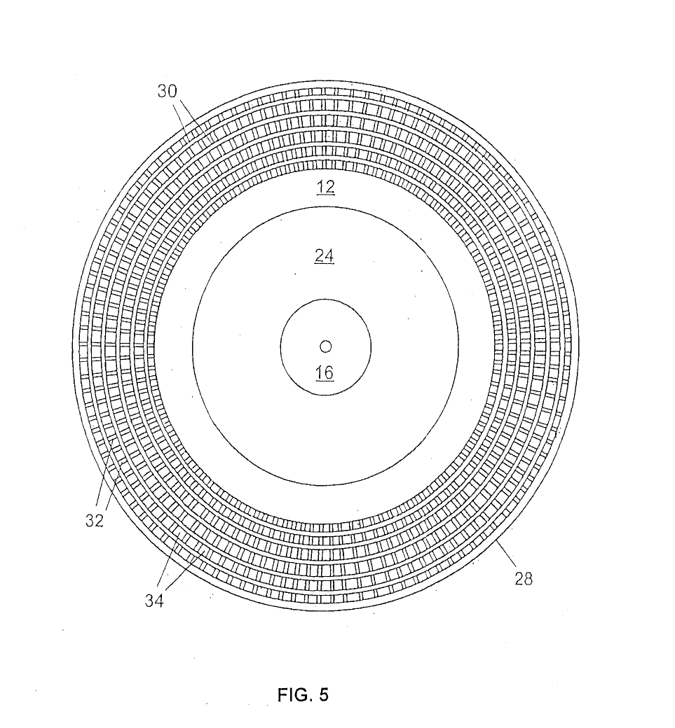

The sealing structure of the capsule is illustrated in FIG. 5 and comprises a plurality of continuous concentric circumferentially extending ribs 30 which intersect with a plurality of radially extending ribs 32 to form a grid pattern.

The ribs 30 and 32 stand proud of that surface of the flange, designated 34 in FIG. 5, which during extraction faces the pressing sleeve of the extraction machine.

Whilst circumferentially extending circular ribs and radial ribs are preferred, any pattern which forms a grid can be used. For example, the ribs 30 can be sinuous and vary in diameter, as measured from the axis of the capsule, instead of being circular and of constant diameter as illustrated.

The ribs 32 can be at an angle to those illustrated so that they intersect the ribs 30 at an angle other than a right angle.

In a still further form the ribs 30 are omitted and the capsule has only radially extending ribs 32 or ribs which are skew to radial and extend from the wall 12 to the bead 28.

In FIG. 5 there are five concentric equally spaced ribs 30. It will be understood that the number can be varied and that there can be more or less than five ribs. The number of radial ribs 32, and hence the spacing between them, can also be varied by increasing or decreasing the number of ribs and hence decreasing or increasing the spacing between them.

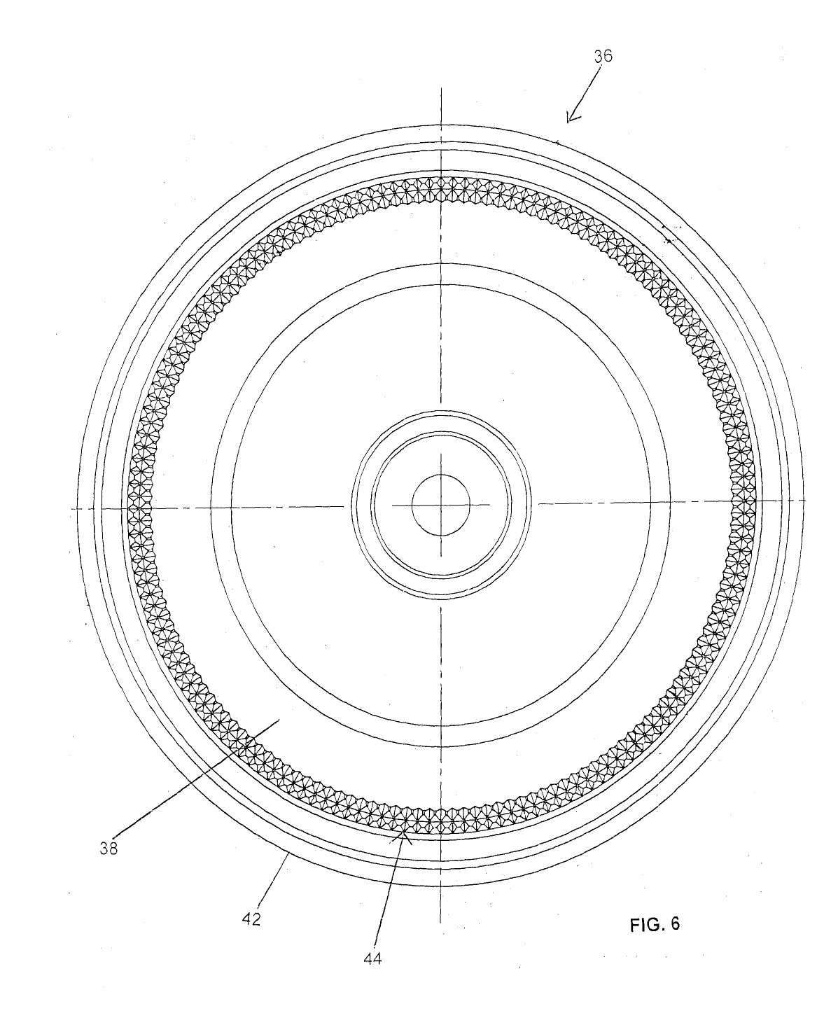

The capsule illustrated in FIGS. 6 to 9 is designated 36. Its frustoconical wall is designated 38 and its flange is designated 40.

There is a strengthening bead 42 around the outer periphery of the flange 40 which minimises flexing of the flange during extraction.

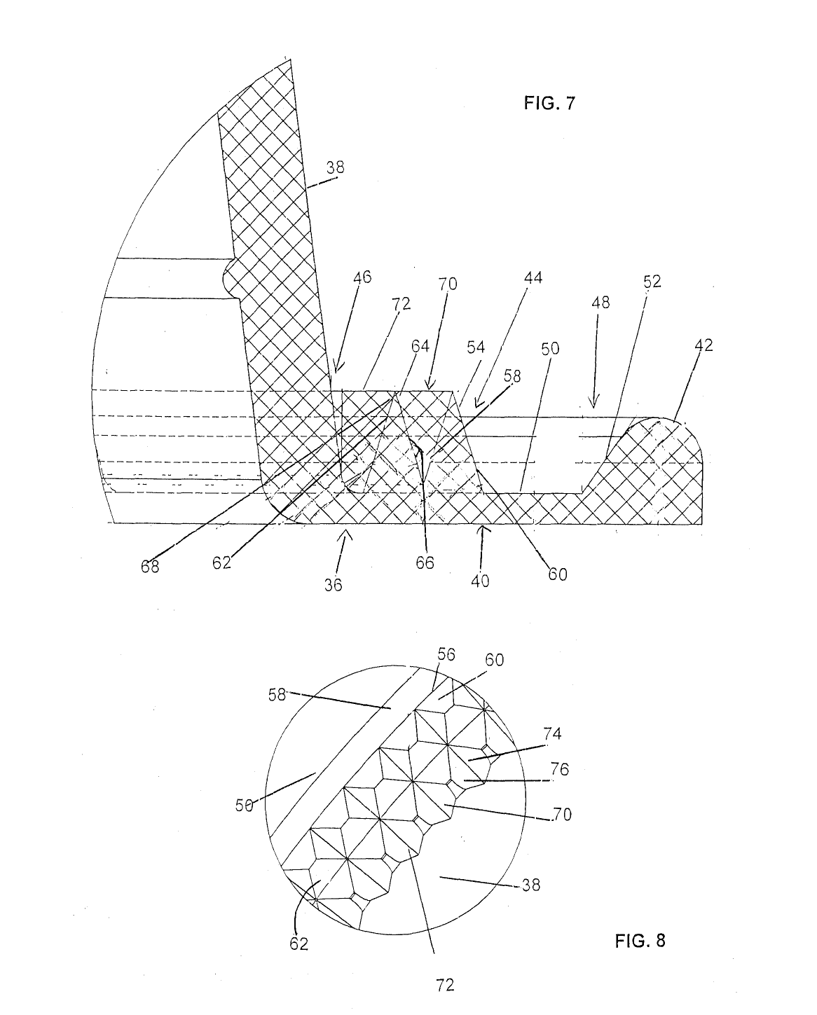

A sealing structure 44 of the capsule 36 is illustrated in detail in FIGS. 7, 8 and 9.

Between the sealing structure 44 and the wall 38 there is a narrow gap 46 (FIG. 7) which widens in the direction away from the flange 40 as a result of the tapering shape of the wall 38. There is a groove 48 between the sealing structure 44 and the bead 42. The bottom of the groove 48 is constituted by a horizontal, circumferentially extending surface 50. The radially outer boundary of the groove 48 is constituted by a sloping flank 52 which also forms the radially inner surface of the bead 42.

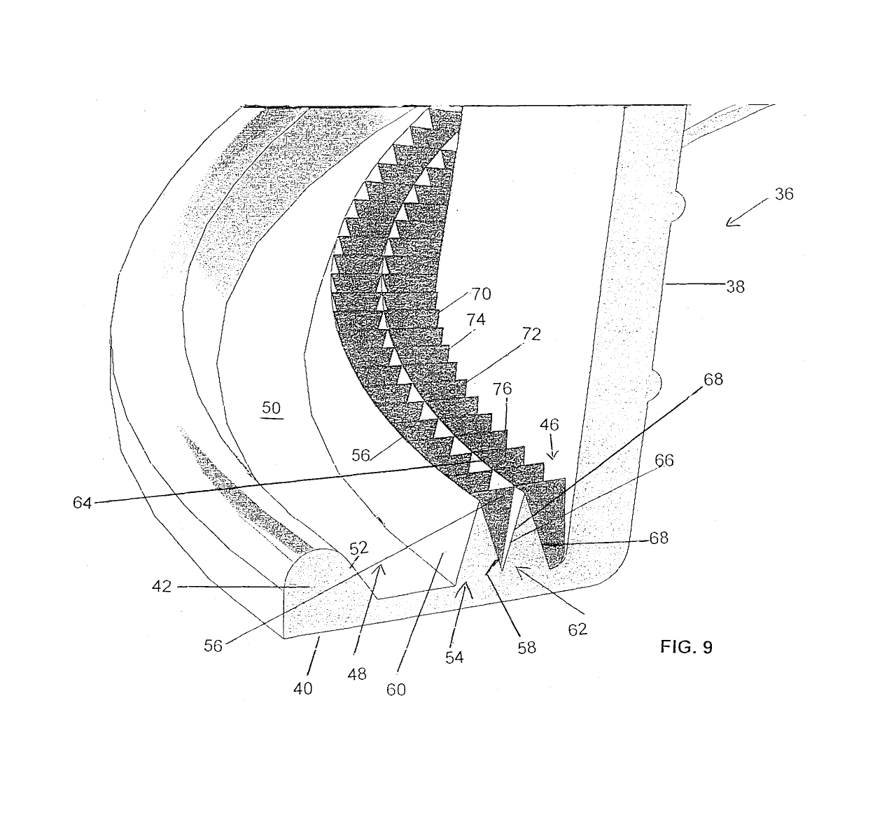

The sealing structure itself comprises a radially outer flimsy sealing rib 54 of triangular shape. This rib extends circumferentially and forms the radially inner boundary of the groove 48. The rib 54 is best seen in FIG. 9 and has an apex 56 and two sloping flanks 58,60.

A second circumferentially extending flimsy sealing rib is designated 62. The ribs 54, 62 are horizontally spaced and are parallel to one another. The rib 62 has an apex 64 and two sloping flanks 66, 68.

An array of radially extending flimsy sealing ribs 70 is also provided. At their radially outer ends the ribs 70 are integral with the rib 54. Each rib 70 crosses the rib 62 so that there are parts of each rib 70 radially inwardly and radially outwardly of the rib 62. Each rib 70 terminates adjacent to, but is not joined to, the wall 38. Reference numeral 72 designates the radially extending apex of each rib 70 and reference numerals 74 and 76 the sloping flanks of the ribs 70. This configuration is best seen in FIG. 7 where the cross sectional shapes of the ribs 54, 62 are shown in dashed lines.

The flanks of all the ribs define included angles of 35° at the apices of the ribs, as indicated in FIG. 7.

In use the pressing sleeve of the extracting machine encounters the apices 56, 64 and 72 of the ribs 54, 62 and 70 and crushes them thereby to seal between the ribs and the pressing sleeve.

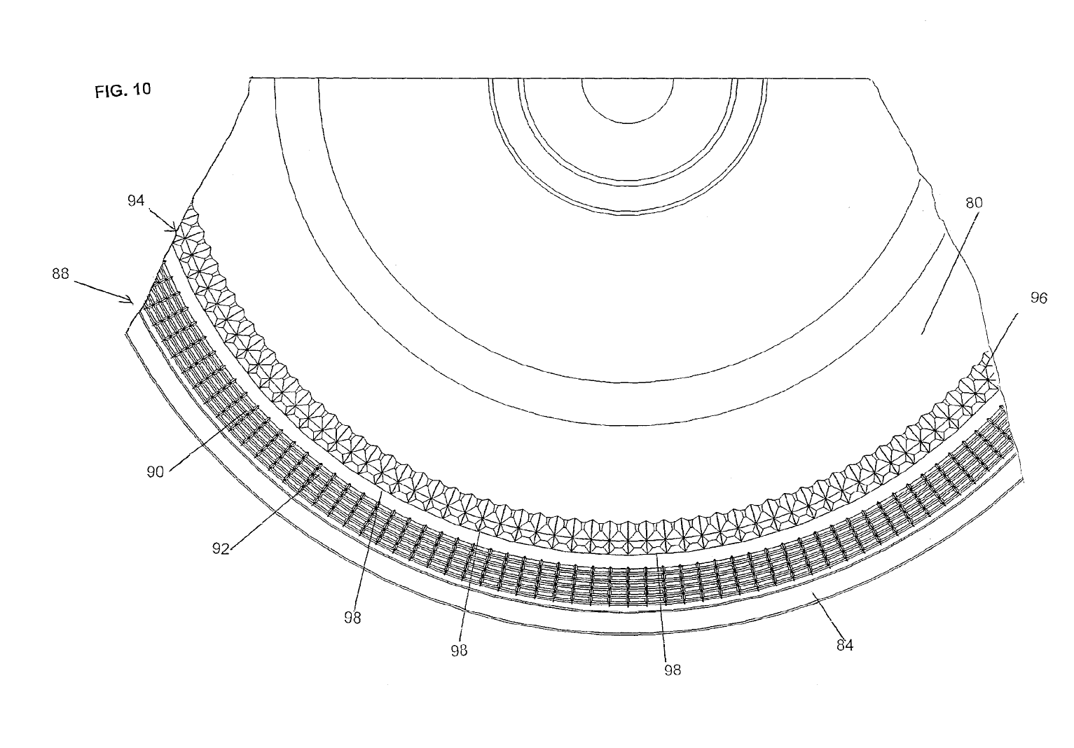

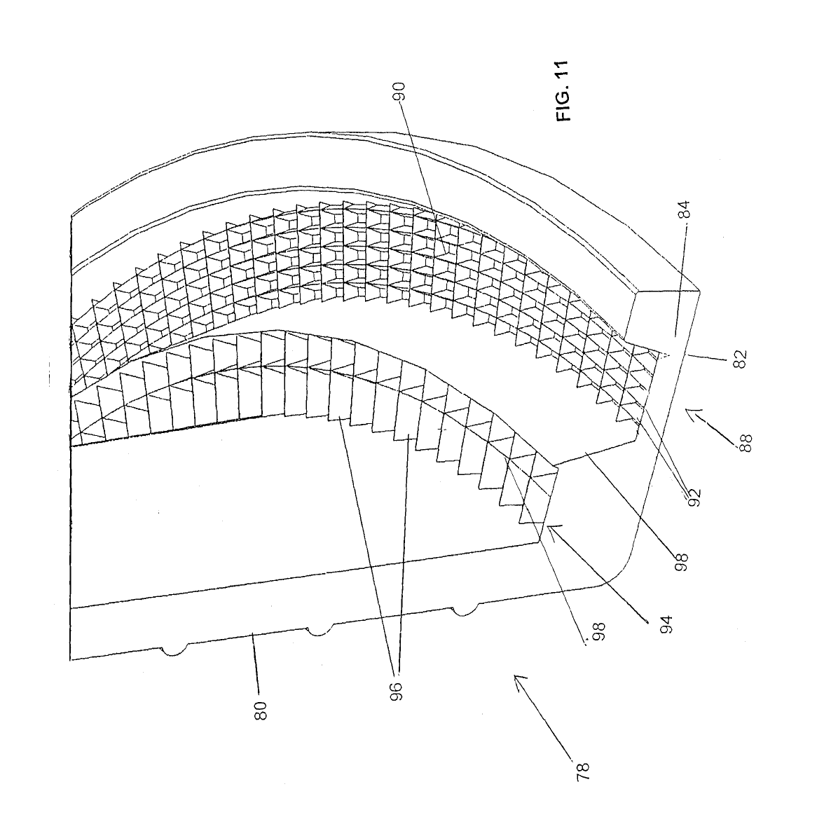

The capsule 78 illustrated FIGS. 10 and 11 of the drawings is similar in general configuration to the capsule 10. Its frustoconical wall is designated 80 and its flange is designated 82.

There is a strengthening bead 84 around the outer periphery of the flange 82 which minimises flexing of the flange during extraction. The bead 84 is substantially square in cross section. There is a sealing structure between the wall 80 and bead 84.

The sealing structure comprises two sealing zones constituted by an outer ring 88 of radially extending ribs 90 and circumferentially extending ribs 92, and an inner ring 94 comprising radially extending ribs 96 and circumferentially extending ribs 98. There are five concentric circular ribs 92 which intersect the ribs 90.

There are fewer ribs 96 than there are ribs 90. One rib 98 intersects the ribs 96 midway between their radially inner and radially outer ends and another rib 98 forms the radially outer edge of the ring 94.

All the ribs are triangular in cross section, their bases being integral with the flange 82 and their apices being free. Each rib consequently has two inclined flanks which meet at an apex. The included angle between the inclined flanks is in this form 28 degrees.

The ribs are all flimsy in nature so that they can readily be crushed when the pressing sleeve of the extraction machine is pressed against them.

In use the pressing sleeve of the extracting machine encounters the apices of the ribs and crushes them thereby to seal between the ribs and the pressing sleeve.

1. A capsule for containing ground coffee, the capsule comprising a frustoconical side wall of truncated conical form which is closed at its narrower end by a base and which has at the wider end a flange which encircles the side wall and extends radially outwardly therefrom, the flange having a first surface to which a foil is secured to close the capsule and an opposed surface which faces the pressing sleeve of the extraction machine when the capsule is placed in the machine prior to extraction taking place, there being a grid pattern of intersecting sealing ribs on said opposed surface which ribs stand proud of said opposed surface.

2. A capsule as claimed in claim 1, and including continuous circumferentially extending concentric ribs which intersect a plurality of radially extending ribs to form said grid pattern.

3. A capsule for containing ground coffee, the capsule comprising a frustoconical side wall of truncated conical form which is closed at its narrower end by a base and which has at the wider end a flange which encircles the side wall and extends radially outwardly therefrom, the flange having a first surface to which a foil is secured to close the capsule and an opposed surface which faces the pressing sleeve of the extraction machine when the capsule is placed in the machine prior to extraction taking place, there being a plurality of radially extending sealing ribs on said opposed surface which ribs stand proud of said opposed surface.

4. A capsule for containing ground coffee, the capsule comprising a frustoconical side wall of truncated conical form which is closed at its narrower end by a base and which has at the wider end a flange which encircles the side wall and extends radially outwardly therefrom, there being a strengthening bead around the periphery of said flange, the flange having a first surface to which a foil is secured to close the capsule and an opposed surface which faces the pressing sleeve of the extraction machine when the capsule is placed in the machine prior to extraction taking place, there being a plurality of sealing ribs on said opposed surface which ribs stand proud of said opposed surface and extend from said wall to said bead.

5. A capsule for containing ground coffee, the capsule comprising a frustoconical side wall of truncated conical form which is closed at its narrower end by a base and which has at the wider end a flange which encircles the side wall and extends radially outwardly therefrom, the flange having a first surface to which a foil is secured to close the capsule and an opposed surface which faces the pressing sleeve of the extraction machine when the capsule is placed in the machine prior to extraction taking place, there being intersecting sealing ribs on said opposed surface which ribs stand proud of said opposed surface, there being ribs which extend radially and which intersect ribs that extend circumferentially, the ribs being triangular in cross section with their bases integral with the flange.

6. A capsule as claimed in claim 5, wherein pairs of sloping flanks bound each rib and intersect with one another at an angle of between 25 and 45 degrees.

7. A capsule as claimed in claim 6, wherein the angle is between 30 to 40 degrees.

8. A capsule as claimed in claim 7, wherein the angle is 35 degrees.

9. A capsule for containing ground coffee, the capsule comprising a frustoconical side wall of truncated conical form which is closed at its narrower end by a base and which has at the wider end a flange which encircles the side wall and extends radially outwardly therefrom, the flange having a first surface to which a foil is secured to close the capsule and an opposed surface which faces the pressing sleeve of the extraction machine when the capsule is placed in the machine prior to extraction taking place, there being intersecting sealing ribs on said opposed surface which ribs stand proud of said opposed surface, there being ribs which extend radially and which intersect ribs that extend circumferentially, the ribs being triangular in cross section with their bases integral with the flange, the ribs being located in two sealing zones constituted by a radially inner ring of ribs and a radially outer ring of ribs, the ribs of the radially inner ring being greater in height and base width than the ribs of the outer ring.

10. A capsule as claimed in claim 9, wherein the outer ring comprises more radially extending and circumferentially extending ribs than the inner ring.

11. A capsule as claimed in claim 9, wherein the inner ring comprises two circumferentially extending ribs one of which intersects the radially extending ribs midway between their radially inner and radially outer ends.

12. A capsule as claimed in claim 11, wherein the other of the circumferentially extending ribs constitutes the radially outer edge of the inner ring.

13. A capsule as claimed in claim 12, wherein the outer ring comprises five circumferentially extending ribs.

14. A capsule as claimed in claim 10, wherein each rib is bounded by sloping flanks which intersect with one another at an angle of between 25 and 45 degrees.

15. A capsule as claimed in claim 14, wherein the angle is between 30 to 40 degrees.

16. A capsule as claim 15, wherein 15 angles is 28 and 35 degrees.

17. A capsule as claimed in claim 10 and including a strengthening bead of substantially square cross-section around the periphery of the flange.

18. A capsule as claimed in claim 10, wherein the inner ring comprises two circumferentially extending ribs one of which intersects the radially extending ribs midway between their radially inner and radially outer ends.

19. A capsule as claimed in claim 11, wherein each rib is bounded by sloping flanks which intersect with one another at an angle of between 25 and 45 degrees.

20. A capsule as claimed in claim 12, wherein each rib is bounded by sloping flanks which intersect with one another at an angle of between 25 and 45 degrees.
